(19) United States
(12) Patent Application Publication
(10) Pub. No.: US 2023/0081799 A1
(43) Pub. Date: Mar. 16, 2023

(54) ASSISTANT PIECE TO HELP READ DESCRIPTIONS WITH EASE

(71) Applicants: HOP LIMITED LIABILITY COMPANY, Sabae-shi, Fukui (JP); EMORI PLANNING CO., LTD., Fukui-shi, Fukui (JP)

(72) Inventor: Hideaki OHARA, Sabae-shi (JP)

(73) Assignee: HOP LIMITED LIABILITY COMPANY, Sabae-shi, Fukui (JP)

(21) Appl. No.: 17/799,620

(22) PCT Filed: Feb. 1, 2021
(86) PCT No.: PCT/JP2021/003529

§ 371 Date: Aug. 12, 2022

(30) Foreign Application Priority Data
Feb. 13, 2020 (JP) 2020-022423

(51) Int. Cl. G02C 7/16

(52) U.S. Cl. CPC G02C 7/16

(57) ABSTRACT

An assistant piece helps in reading descriptions for those who have presbyopia and farsightedness. The piece dispenses with eyeglasses or special instruments and through which piece the letters etc. at hand are readily readable in various situations. The assistant piece has a plurality of ocular sections each having a prescribed area which are provided in juxtaposition on a plate-like sheet member and through which light penetrates and a line of vision introduction section which is provided in the vicinity of the ocular sections and has a larger light penetrating area than the ocular sections, in which the sheet member is provided with a light-shielding section whose transmittance over visible light is lower than those of the ocular sections and the line of vision introduction section; and the ocular sections and the line of vision introduction section are provided within the light-shielding section.

### TECHNICAL FIELD

The present invention relates to an assistant piece which has the function to correct presbyopia and farsightedness and helps read descriptions such as letters, numbers, signs or symbols and figures (hereinafter, referred to as ‘letters etc.’) at hand with ease.

### BACKGROUND ART

Such important information as substances, ingredients and cautions for use is printed on the packages for medicines, foodstuffs and the like, so that it is demanded that such information be understandably readable upon use or consumption.

However, generally speaking, such information is described with small letters within the limited space of such packages so that especially the people having presbyopia and farsightedness are facing the problem with which they can't read it without an assistant piece to help read descriptions (such as spectacles for the aged and loupes). Specifically, when those who evacuate to the sheltering sites for refugees by dropping everything without carrying a pair of eyeglasses with them in emergency under natural disasters, it often happens that they have a hard time reading the descriptions printed on such life-saving supplies as medicines and foodstuffs possibly distributed in such sheltering sites.

Further, unless they can read names, effect or efficacy of the medicines and such cautions as method of use, dose and sub-effects as well as such descriptions as raw materials of the foodstuffs, there is risk that they might face serious problems with their lives because they unavoidably suffer from e.g. sub-effects of the medicines or allergy to the foodstuffs through wrong use or consumption.

Such an assistant piece for that purpose is conventionally known (refer to the disclosure of Document 1) as improving portability for everyday use and taking advantage of the so-called pinhole effect.

However, this prior art is faced with the problem with which because it is necessarily required to carry such piece with the users, there is likelihood that carrying it with them or the place where it has been stored might slip their minds.

On the other hand, such an optical piece for objective observation is disclosed (refer to the description of Document 2) as taking advantage of the pinhole effect as well and being able to be put to use by forming such piece on a part of such stationeries as a ruler at hand or a book cover and the like even when such assistant piece is unavailable.

However, this prior art is faced with the problem with which it is of no use unless the articles on which such optical piece is formed are not conveniently at hand and even if the piece is formed on an article, it is difficult to know how to use it at a glance.

### CITATION

### PATENT LITERATURE

Document 1: Japanese Unexamined Utility Model Application Publication No. HEISEI05-29023
Document 2: Japanese Unexamined Patent Application Publication No. SHOWA61-186901

### SUMMARY OF THE INVENTION

### Technical Problem

Thus, in view of the foregoing inconveniences faced with the prior art, the present invention is to provide an assistant piece to help read descriptions with ease for those who have presbyopia and farsightedness, which piece dispenses with eyeglasses or special instruments and through which piece the letters etc. at hand are readily readable in various situations and which piece is easy to be conceived by the users as the vision assist piece and the production cost of which piece is contained lower and which piece is applicable to such various articles as Scotch tapes and storing cases besides packages.

### Solution to Problem

The means adopted by the inventor to solve the above issues is as follows.

The assistant piece to help read descriptions with ease according to the present invention is characterized in comprising a plurality of ocular sections each having a prescribed area which are provided in juxtaposition on a plate-like sheet member and through which light penetrates and a line of vision introduction section which is provided in the vicinity of the ocular sections and has a larger light penetrating area than the ocular sections, in which the sheet member is provided with a light-shielding section whose transmittance over visible light is lower than those of the ocular sections and the line of vision introduction section; and the ocular sections and the line of vision introduction section are provided within the light-shielding section.

Further, it is preferred that an interval between the adjacent ocular sections range from 3.0 mm to 4.5 mm, and an interval between the line of vision introduction section and the closest ocular section range from 3.0 mm to 4.5 mm and it is more preferred that the interval between the line of vision introduction section and the closest ocular section be the same as or larger than that between the adjacent ocular sections. In this regard, what is referred herein to as the interval between the line of vision introduction section and the closest ocular section denotes the shortest distance connecting between the contour lines of the ocular sections or between the contour lines of the line of vision introduction section and the closest ocular section.

Additionally, the shape of the ocular section may be other than the circle and it is preferred that the aerial size of the ocular section or converted into circle diameter range from O0.5 mm to O2.0 mm and that of the line of vision introduction section be O4.0 mm or smaller. In this regard, the aerial size of the line of vision introduction section may be twice as large as that of the ocular section or much larger than that.

Further, the ocular sections can be arranged with plural lines, in which the interval between the respective lines is 4.0 mm or larger or can be the same as that between the line of vision introduction section and the closest ocular section or larger than that as well.

Furthermore, the sheet member can be formed into separable pieces while being attached to an object for visual recognition.

### Advantageous Effect

With the assistant piece to help read descriptions with ease according to the present invention, it facilitates such short messages as cautions noted on the packages for medicines, foodstuffs and the like to be readily read by forming it into separable pieces to be attached to an object for visual recognition or placing it on the sites of its utilization even when the users forget carrying the vision assist piece with them.

Moreover, providing the line of vision introduction section larger than the ocular section in the vicinity of the latter allows the users to visually recognize the former which is larger than the latter even when they have the vision too weak to visually recognize minute pinholes and also permits them to visually recognize an object for visual recognition through the latter smaller in size which makes the image of such object clearer and comes into their visual range simultaneously upon peeping through the former.

Furthermore, defining the interval between the ocular sections as ranging from 3.0 mm to 4.5 mm and that between the line of vision introduction section and the closet ocular section as ranging from 3.0 mm to 4.5 mm prevents the adjacent letters from being overlapped in sight or the full sentence from being segmented on the way with just a single letter in sight on some occasions, so that such advantageous effect is brought as the letters being able to be read in the form of the full sentence.

In this regard, making the interval between the line of vision introduction section and the closet ocular section the same as that between the ocular sections or larger than that brings the effect of preventing the adjacent letters from being overlapped in sight upon visually recognizing the line of vision introduction section comparatively larger in size at first.

In addition, making the diameter of the ocular section taking circle in shape range from O0.5 mm to O2.0 mm and that of the line of vision introduction section taking circle in shape O4.0 mm or smaller permits the pinhole effect to improve even in brighter or shadowy surroundings, which brings the effect of enabling most of the users to read the letters etc. even when each of them has difference in visual strength.

Furthermore, making the line of vision introduction section twice as large as the ocular section or larger than that allows the users to visually recognize the former clearly even when they have the vision too weak to visually recognize minute pinholes and to visually recognize the ocular section coming into their visual range simultaneously upon peeping through the former. For good measure, the light penetrated from the line of vision introduction section makes an object for visual recognition brighter, on top of which the line of vision introduction section in itself functions as the pinhole as well, so that a number of letters can be visually recognized at one time.

To note, by the ocular sections being constituted by a plurality of lines and rows and making an interval between the respective lines 4.0 mm or larger as well as making such interval the same as that between the line of vision introduction section and the closest ocular section or larger than that, it brings the effect of making it possible to read letters in various surroundings such as brighter outside and murky places like shelters.

On the other hand, by making a part of the object for visual recognition the sheet member, it permits the ocular section and the line of vision introduction section to be formed through perforation or printing, so that the assistant piece can be produced at a reasonable cost.

The present invention brings the above-mentioned effects, in which in Japan where the number of natural disasters increases and population aging is a major concern for the society, using the assistant piece according to the present invention which is disposed in, accompanied with or pasted to the packages for medicines, foodstuffs and the like provisioned to the refugees at the shelters etc. and as such or with which the shelters etc. are equipped in such a condition that the refugees don't carry any vision assist piece with them permits them to read such cautions as printed on the packages in which life-saving stuffs are contained, so that such medicines and foodstuffs can be safely taken or consumed without worrying about any side effect or allergy caused by wrong use or consumption.

Moreover, at the shelters, the assistant piece attached to the provisioned products or the card-like assistant piece with which the shelters are equipped can be used in order to browse a smartphone or notes circulated among the refugees or the assistant piece built in the container of the thermometer can be used in order to check the display of such meter upon measurement. In this way, the present assistant piece can be applied to various articles besides medicines, foodstuffs and the like.

Further, such effect is brought by the present invention as enabling not only those who have presbyopia caused by aging, but also the young people who suffer from eye strain caused by browsing a smartphone etc. and have the similar symptom to presbyopia to readily read the letters at hand by using the present assistant piece.

There are a lot of foreign countries which face the same problems as noted above, in which the means, which allows the letters etc. to be readily read, can be provided with a reasonable price to the users who cannot possess the vision assist piece provided with optic lenses such as eyeglasses due to economic situation, poverty and as such, so that the present assistant piece is considered high in industrial applicability.

### BRIEF DESCRIPTION OF THE DRAWINGS

FIG. 1 is a frontal view of the assistant piece according to the first example of the present invention;

FIG. 2 shows explanatory views illustrating how to use the assistant piece and the visual recognition state upon guiding the line of vision;

FIG. 3 shows explanatory views illustrating the visual correction principle applied for the naked eyes and applied when a pinhole is used in terms of presbyopia respectively;

FIG. 4 shows explanatory views illustrating difference in visibility between one pinhole and plural pinholes;

FIG. 5 shows explanatory views illustrating difference in visibility between narrower interval between pinholes and wider interval between them in terms of the plural pinholes;

FIG. 6 shows explanatory views illustrating images of visual recognition at the verification test 1;

FIG. 7 is a frontal view of the exemplified assistant piece used for the verification test 1;

FIG. 8 is a frontal view of the exemplified assistant piece used for the verification test 3;

FIG. 9 shows perspective views illustrating the assistant piece according to the second example, the piece being attached to an object for visual recognition in the form of a package;

FIG. 10 shows perspective views illustrating the assistant piece according to the third example and explanatory views illustrating the state in which the assistant piece is used, the piece being attached to an object for visual recognition in the form of a package;

FIG. 11 shows a perspective view illustrating the assistant piece according to the fourth example, the piece being accompanied as a separate body with an object for visual recognition in the form of a package;

FIG. 12 shows a perspective view illustrating the assistant piece according to the fifth example, the piece being pasted as a separate body to an object for visual recognition in the form of a bottle;

FIG. 13 shows a perspective view illustrating the assistant piece according to the sixth example, the piece being attached to the lid of an object for visual recognition in the form of a bottle;

FIG. 14 shows a perspective view illustrating the assistant piece according to the seventh example in the form of a tag;

FIG. 15 shows a perspective view illustrating the assistant piece according to the eighth example, the piece being attached to the cap portion of a thermometer;

FIG. 16 shows a perspective view illustrating the assistant piece according to the ninth example, the piece being attached to an object for visual recognition in the form of a blister pack package;

FIG. 17 shows perspective views illustrating the assistant pieces according to the tenth example in the form of a bookmarker and a sticky note;

FIG. 18 shows a perspective view illustrating the assistant piece according to the eleventh example in the form of a tape; and

FIG. 19 shows frontal views illustrating the assistant pieces according to the twelfth example, the shapes of the line of vision introduction sections of which are modified.

### EMBODIMENT

The first example of the present invention is explained with reference to FIGS. 1 to 5.

The assistant piece 1 according to the present example, as illustrated in FIG. 1, is arranged such that plural ocular sections 2 are juxtaposed with a certain interval between them on a plate-like sheet member 4 and a line of vision introduction section 3 is provided in the vicinity of the endmost ocular section 2.

The plural ocular sections 2 each have a prescribed area to let light penetrate and comprise a circular hole according to the present example. The line of vision introduction section 3 has a prescribed area to let light penetrate and comprises a circular hole according to the present example as well, but the hole size is larger than that of the ocular sections 2 respectively. It should be noted that the ocular sections 2 and the line of vision introduction section 3 are not limited to a hole just if light can penetrate through them or may comprise a transparent film for an example and the shape of the ocular section 2 and the line of vision introduction section 3 is not limited to a circular one.

On the other hand, the sheet member 4 is provided with a light-shielding section 5 whose transmittance of visible light is lower than that of the ocular section 2 and the line of vision introduction section 3, in which the ocular sections 2 and the line of vision introduction section 3 are disposed in the light-shielding section 5. According to the present example, it is arranged such that the sheet member 4 as a whole comprises the light-shielding section 5. To note, it is just fine as long as the ocular sections 2 and the line of vision introduction section 3 are disposed in the light-shielding section 5, in which only the peripheries of the ocular sections 2 and the line of vision introduction section 3 of the sheet member 4 may comprise an untransparent print and the rest of the sheet member 4 may comprise a transparent film and the like, in which case it is preferred that the interval between the ridgeline of the ocular section 2 and the line of vision introduction section 3 respectively and that of the light-shielding section 5 be 3.0 mm or larger.

Now, explanation is given on how to use the assistant piece 1 according to the present example.

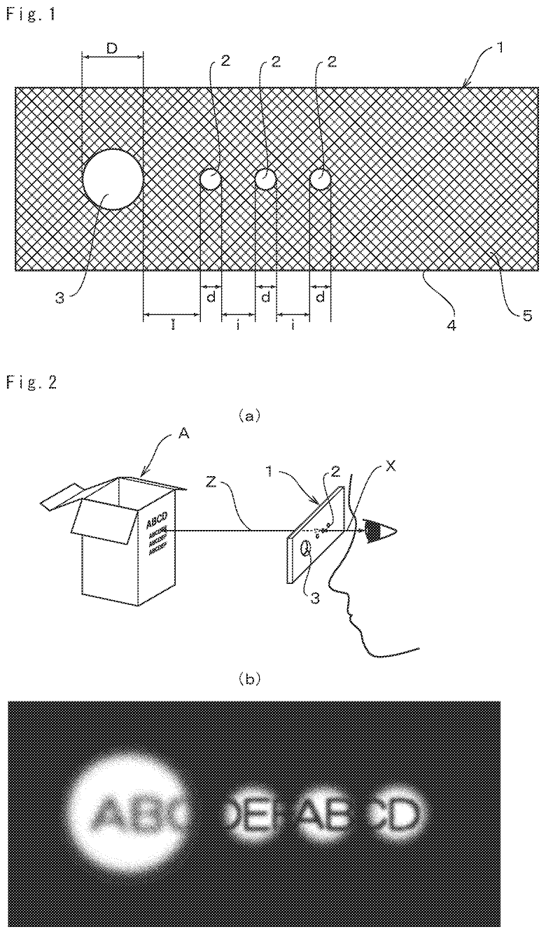

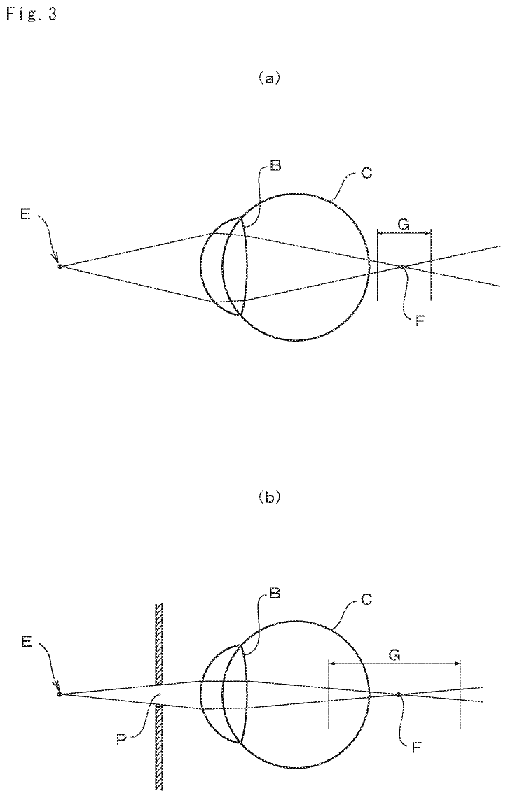

According to the present example, as illustrated in FIG. 2(a), the assistant piece 1 is put to use by disposing the same such that any one of the ocular sections 2 of the piece coming closer to the eyes can be peeped through. Then, an object for visual recognition A is disposed in front of the eyes and a distance X between the piece and the user's eyes and a distance Z between the object and the piece are adjusted by the user where appropriate such that the letters etc. can be visually recognized.

Upon the ocular sections 2 being peeped through, when the user has presbyopia or farsightedness, there are some cases where he/she cannot recognize the presence of such sections because of their smallness in size. However, according to the present example, by the line of vision introduction section 3 larger than the ocular sections 2 being provided in the vicinity of the latter, it permits him/her to be able to recognize the former in the first place.

Then, as illustrated in FIG. 2(b), upon the user peeping through the line of vision introduction section 3, an image looks blurred due to the poor pinhole effect (explained below) because the section 3 is larger than the sections 2, but the ocular section 2 closest to the line of vision introduction section 3 naturally comes into his/her visual range at the same time, thereby, permitting him/her to be able to visually recognize the neighboring ocular sections 22 through which such image looks comparatively clearer in a successive manner so as for him/her to be able to visually recognize a sentence through the juxtaposed ocular sections 2.

In this way, even the users who have difficulty seeing not only the letters etc. at hand, but also the ocular sections 2 themselves due to presbyopia or farsightedness can visually recognize the sections 2 by making him/her recognize and peep through the line of vision introduction section 3, thereby, allowing him/her to read the letters etc. smaller in size.

(On Pinhole Effect)

By the way, the assistant piece 1 according to the present example takes advantage of the principle or a so-called pinhole effect. In the case of the typical presbyopia, the adjustment function of the thickness of the lens B deteriorates owing to aging. As illustrated in FIG. 3(a), especially when a thing nearer to a looker is seen, because the focal point F is shifted behind the retina C and the range of the focal depth G is not within the retina C, light emitted from a light source E (in fact, light reflected mainly from an object for visual recognition) is not rendered into an image so that the image looks blurred and becomes hard to be visually recognized in the same way as farsightedness.

Thus, as illustrated in FIG. 3(b), disposing in front of the eyes a pinhole P in which light penetrates just through a small hole and the periphery of such hole is shielded against light, the amount of light entering the eyes is limited to a great extent. The thin flux of the light penetrated through the pinhole P is refracted at the lens B and is rendered into an image at the focal point F shifted behind the retina C, but it is made incident on the retina C with an acute angle so that the range of the focal depth G becomes wider. Therefore, such image can be visually recognized without blur even when the looker has presbyopia.

To note, generally speaking, it is usual to use a pair of eyeglasses for the aged in which the optical lenses are mounted in order to rectify the focal point. Compared with the optical lenses, the pinhole effect is characterized in that the range of the focal depth G is wider.

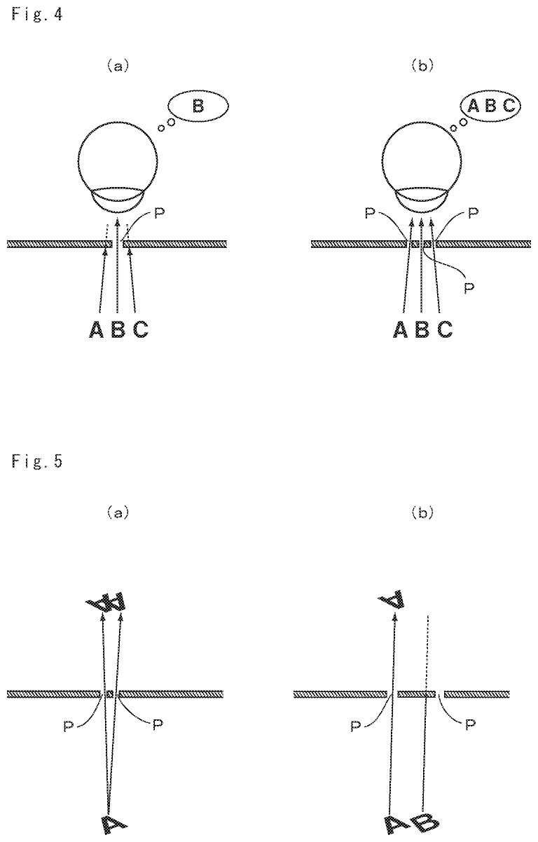

However, as illustrated in FIG. 4(a), just with one pinhole P, such problems arise as an image disappearing from the looker's visual range just with the line of vision shifted a bit and having difficulty understandably reading a sentence because the adjacent contextual letters cannot be read, though those within an extremely narrow range can be read.

Thus, as illustrated in FIG. 4(b), juxtaposing plural pinholes P facilitates the adjacent contextual letters to be understandably read. For an instance, if the number of pinholes P is increased in accordance with a targeted sentence, it allows such sentence to be contextually read.

However, the number of pinholes P being large, the proportional ratio of occupancy by the assistant piece 1 to an object for visual recognition A becomes large when the piece 1 is attached to such object, so that it may ruin the visual appearance of a product concerned. Thus, by limiting the number of pinholes P to several holes and making it possible to transversely move them along a sentence, it permits a sentence, if it is short in length, to be readjust with the smaller occupancy of the assistant piece to such product.

On the other hand, as illustrated in FIG. 5(a), juxtaposing plural pinholes P, if an interval between the respective pinholes is too narrow, makes it hard to read a sentence due to the overlapped letters. In turn, if such interval is too wide, just one letter can be visually recognized and it makes it hard to understandably read a sentence because the contextual letters are segmented on the way.

Further, the thinner the light flux made incident on the retina C by making the pinhole P smaller becomes, the less an image becomes blurred due to the widened range of the focal depth G while the darker such image becomes accordingly, thereby, making it hard to understandably read the letters etc. especially when the surrounding is murky or visual recognition condition is poor.

(Verification Test 1)

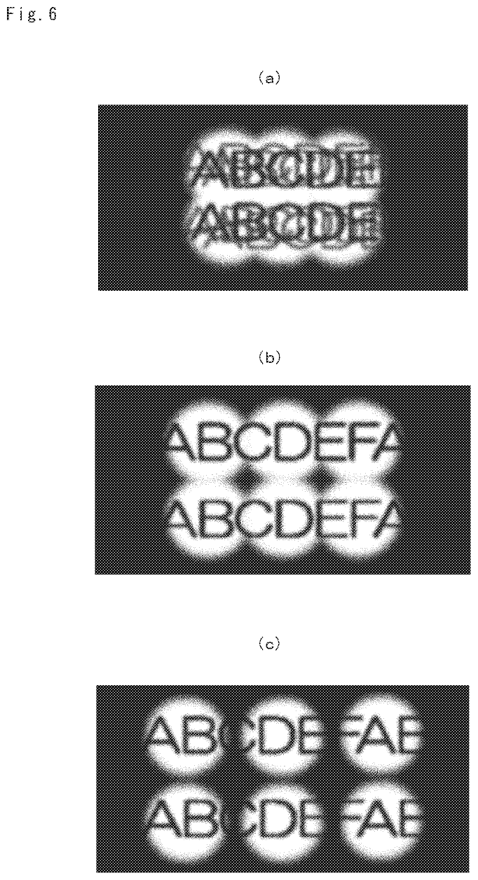

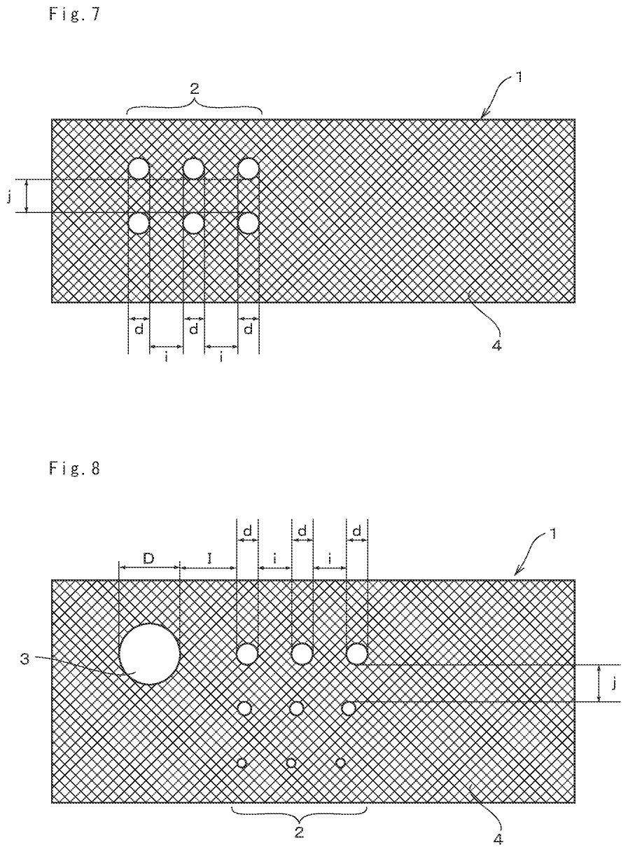

Therefore, the verification test has been carried out for tabling for discussion which numerical values for the largeness of the pinhole P and the interval between the adjacent pinholes P should be set to obtain the optimal assistant piece 1. The verification test on the optimization of the present invention in terms of configuration and the resulting effect is explained with reference to FIGS. 6 and 7.

To begin with, in this test, a plurality of assistant piece samples having a diameter d of the ocular section and a transverse interval i between the adjacent ocular sections different from one another has been produced and evaluation has been made on each sample, when a series of letters included in the Japanese and English sentences illustrated in the following Table 1 according to different sizes are seen, as to what has been seen is similar to which image or any one of images (a) to (c) (corresponding to FIG. 6(a) to FIG. 6(c)) or the preliminarily prepared visual recognition images and which image has been easy to be visually recognized. The sizes of the letters comprise three ones: 10 pt (about 3.53 mm); 8 pt (about 2.82 mm); and 6 pt (about 2.12 mm).

TABLE 1 [symbol]
• [symbol] Method of Use and Dosage [symbol]
1 [symbol] 1 [symbol] 2 [symbol] ( [symbol] • [symbol] ), [symbol] [symbol] [symbol]
Please take the following one dosage twice
a day (morning and evening) together with tap water or warmed water. [symbol]
Efficacy [symbol]
( [symbol] , [symbol] , [symbol] , [symbol] , [symbol] , [symbol]
, < [symbol] [symbol] , [symbol] , [symbol] [symbol]
, [symbol] ) [symbol] Alleviation of
various symptoms of cold (fever, sore throat,
coughing, runny nose, congested nose, phlegm, chillness, joint pain,
muscle pain)
Autumn
Kuzuryu Lake Surrounded in abundant nature, the emerald waters of
Kuzuryu Lake reflect the brightly colored autumn leaves as far
as the eye can see

The assistant piece samples according to the present test use a sticky note as the sheet member 4 and the light-shielding section 5 is arranged with the frontal surface of the sticky note coated with a black ink. In this regard, the perforated samples have been prepared by defining the diameter d of the ocular section as having two dimensions or O1.3 mm and O0.8 mm (the processing error being in the order of ±0.1 mm) and defining a transversal interval i between the adjacent ocular sections as having five dimensions or 2.5 mm, 3.0 mm, 3.5 mm, 4.0 mm and 4.5 mm (the processing error being in the order of ±0.1 mm).

The ocular sections 2, as illustrated in FIG. 7, comprise plural stages having two line and three rows and the line of vision introduction section 3 is not provided such that it gives no influence on the present test. In this regard, the vertical interval j between the adjacent ocular sections is arranged to be the same as the transversal interval i between the adjacent ocular sections.

The examinees comprise five persons mainly having presbyopia, two persons having mainly having farsightedness and two persons mainly having myopia or nine persons in total, in which their right and left eyes respectively are subjected to the present test. In this relation, the present test has been carried out under white-colored light of about 750 lux which corresponds to the luminance with which the letters etc. at hand can be seen well when reading a book and the like and by defining the interval between the assistant piece sample and the respective eyes as about 12 mm which is the norm in distance between the respective lens of the typical eyeglasses and the respective eyes.

Among the test results obtained under the above conditions, the results of what has been seen being similar to which image or any one of the preliminarily prepared visual recognition images are illustrated in the following table 2. To note, the columns indicated in bold denotes the visual recognition image which the examinees answer is the most similar to what has been seen.

TABLE 2

| | Interval i = 2.5 mm | | | | Interval i = 3.0 mm | | | | Interval i = 3.5 mm | | | | Interval i = 4.0 mm | | | | Interval i = 4.5 mm | | | |
|---|---|---|---|---|---|---|---|---|---|---|---|---|---|---|---|---|---|---|---|---|
| | Diameter d | | | | | | | | | | | | | | | | | | | |
| | ø1.3 mm | | ø0.8 mm | | ø1.3 mm | | ø0.8 mm | | ø1.3 mm | | ø0.8 mm | | ø1.3 mm | | ø0.8 mm | | ø1.3 mm | | ø0.8 mm | |
| | Eyes | | | | | | | | | | | | | | | | | | | |
| | R | L | R | L | R | L | R | L | R | L | R | L | R | L | R | L | R | L | R | L |
| Image (a) | 3 | 5 | 5 | 5 | 4 | 5 | 6 | 4 | 3 | 0 | 0 | 1 | 0 | 1 | 1 | 1 | 1 | 0 | 1 | 1 |
| Image (b) | 4 | 4 | 4 | 4 | 4 | 3 | 3 | 5 | 4 | 7 | 7 | 6 | 6 | 5 | 7 | 5 | 3 | 1 | 3 | 3 |
| Image (c) | 2 | 0 | 0 | 0 | 1 | 1 | 0 | 0 | 2 | 2 | 2 | 2 | 3 | 3 | 1 | 3 | 5 | 8 | 5 | 5 |

Further, the results of which image has been easy to be visually recognized are illustrated in the following table 3. Likewise, the column indicated in bold denotes the visual recognition image which the examinees answer is the easiest to be visually recognized.

TABLE 3

| Visual Recognition Image | Image (a) | Image (b) | Image (c) |
|---|---|---|---|
| Easiest to be visually | 2 | 13 | 3 |
| recognized | | | |

Based on the above results, it has been found that the image illustrated in FIG. 6(b) has the best visibility and the transverse interval i between the adjacent ocular sections having the best visibility or enabling the image illustrated in FIG. 6(b) to appear ranges from 3.5 mm to 4.0 mm.

As for the diameter d of the ocular section, neither O1.3 mm nor O0.8 mm has brought any difference for the visibility of the images.

(Verification Test 2)

Then, the verification test has been carried out for tabling for discussion as to which numerical value the interval I between the ocular section and the line of vision introduction section should have to enable the ocular sections to come into the lookers' visual range for the visual recognition of the ocular sections. The verification test on the optimization of the present invention in terms of configuration and the resulting effect is explained with reference to FIG. 1.

To begin with, in this test, plural assistant piece samples have been prepared having different intervals I between the ocular section and the line of vision introduction section using the same materials and method as the verification test 1 (see FIG. 1). Further, the requisites for the examinees and the test environment are the same as the verification test 1. Subsequently, as for each sample, evaluation has been made, when a series of letters included in the Japanese and English sentences illustrated in the following Table 1 according to different sizes are seen peeped through the line of vision introduction section 3, as to which sample makes the ocular section 2 closest to the line of vision introduction section 3 naturally come into the lookers' visual range and the adjoining ocular sections 2 come into the looker's visual range in a successive manner without a hitch. The letter sizes comprise three ones: 10 pt (about 3.53 mm); 8 pt (about 2.82 mm); and 6 pt (about 2.12 mm).

As for the samples for the present test, the perforated ones have been prepared by defining the diameter d of the ocular section as O1.3 mm, defining the transverse interval i between the adjacent ocular sections as 3.5 mm; defining the diameter D of the line of vision introduction section as 3.1 mm, and defining the interval I between the ocular section and the line of vision introduction section as having three dimensions or 3.0 mm, 4.0 mm and 5.0 mm (the processing error being in the order of ±0.1 mm for each definition).

The test results brought under the above conditions are illustrated in the following table 4. The column indicated in bold denotes the interval I which the examinees answer makes the ocular sections visually recognized in the easiest manner. In this regard, those results denote the total number encompassing each letter size.

TABLE 4

| Interval I (mm) | 3.0 | 4.0 | 5.0 |
|---|---|---|---|
| Easiest to be visually | 9 | 16 | 2 |
| recognized | | | |

Based on the above results, it has been found that the sample whose interval I between the ocular section and the line of vision introduction section is defined as 4.0 mm makes the ocular sections 2 visually recognized in the most natural manner.

(Verification Test 3)

Then, the verification test has been carried out for tabling for discussion as to which state of power of vision the present assistant piece 1 is effective for, presbyopia, farsightedness or myopia and whether or not it is effective even when it is placed in different surroundings with a variety of luminance. The present test is explained with reference to FIG. 8.

To begin with, in this test, one assistant piece sample, the ocular sections 2 of which comprise three lines and as many rows and the diameter d of the ocular section of which is different for each line, has been prepared using the same materials and method as the verification test 1 (see FIG. 8). Further, the requisites for the examinees are the same as the verification test 1, but the test has been carried out for each eye under the following three test surrounding luminous conditions: about 50 lux, about 250 lux and about 750 lux.

Then, evaluation has been made as to how far the prescription of presbyopia has improved for each case with naked eyes and by use of the assistant piece sample when the prescription of presbyopia readily determination table illustrated in Table 5 below is seen peeped through the ocular sections 2 with each eye. In this regard, as for the measurement of the naked eyes, in order to find the reference value of each examinee, the evaluation has been made by fixing the test surrounding luminous condition at about 750 lux and fixing the interval between each eye and the determination table at about 30 cm which is the standard interval used when the determination table is put to use. To note, as for the evaluation by each luminance by use of the assistant piece sample, on the presumption that there is difference in behavior on how to use the assistant piece sample between each individual and providing that the interval between the sample and the determination table is defined as the range from 10 to 40 cm which is adjustable at hand without fixing such interval and the interval between the sample and each eye is defined as the range from 1 to 5 cm which is adjustable even with such interval narrowed without fixing such interval either, it has been made by each examinee adjusting the intervals with which he/she finds it easy to see the ocular sections. To note, the following table 5 is just one example for illustration purpose, so another table may well be used as far as it can determine the prescription of presbyopia.

TABLE 5

| Letters to Measure | | Rough | Letter | Letter |
|---|---|---|---|---|
| Prescription | Prescription | Standard | Size | Size |
| of Presbyopia | of Presbyopia | of Age | (mm) | (pt) |
| Extending longevity of | +4.5 | over 75 y. o. | 8.0 | 22.7 |
| eyes' health | | | | |
| Extending longevity of | +4.0 | over 70 y. o. | 6.8 | 19.3 |
| eyes' health | | | | |
| Extending longevity of | +3.5 | over 65 y. o. | 5.2 | 14.8 |
| eyes' health | | | | |
| Extending longevity of | +3.0 | over 60 y. o. | 4.6 | 13.0 |
| eyes' health | | | | |
| Extending longevity of | +2.5 | over 55 y. o. | 4.0 | 11.4 |
| eyes' health | | | | |
| Extending longevity of | +2.0 | over 50 y. o. | 3.6 | 10.0 |
| eyes' health | | | | |
| Extending longevity of | +1.5 | over 45 y. o. | 2.7 | 7.4 |
| eyes' health | | | | |
| Extending longevity of | +1.0 | over 40 y. o. | 1.6 | 5.2 |
| eyes' health | | | | |

As for the sample for the present test, the perforated one has been prepared by defining the diameter d of the ocular section as O1.3 mm, O1.0 mm and O0.8 mm per line, defining the transverse interval i between the adjacent ocular sections and the vertical interval j between the ocular sections respectively as 3.5 mm; defining the diameter D of the line of vision introduction section as O3.1 mm, and defining the interval I between the ocular section and the line of vision introduction section as 4.0 mm (the processing error being in the order of ±0.1 mm for each definition).

The test results brought under the above conditions are illustrated in the following table 6. In this relation, what is referred to as ‘Z’ is the prescription of presbyopia of the naked eye having better power of vision, what is referred to as ‘z’ is the prescription of presbyopia of the other naked eye, what is referred to as ‘A’ is the prescription of presbyopia by use of the assistant piece under the luminous surrounding of about 750 lux, what is referred to as ‘B’ is the prescription of presbyopia by use of the assistant piece under the luminous surrounding of about 250 lux; and what is referred to as ‘C’ is the prescription of presbyopia by use of the assistant piece under the luminous surrounding of about 50 lux.

TABLE 6
Examinee 1 (presbyopia)

| | |
|---|---|
| Right | Left |

| Prescription | Naked | Samp1e | Naked | Sample |
|---|---|---|---|---|
| +1.0 | | A | | A |
| +1.5 | | B, C | | B, C |
| +2.0 | | | | |
| +2.5 | | | | |
| +3.0 | | | | |
| +3.5 | | | | |
| +4.0 | Z | | z | |

Examinee 2 (presbyopia)

| | |
|---|---|
| Right | Left |

| Prescription | Naked | Sample | Naked | Sample |
|---|---|---|---|---|
| +1.0 | | A | | |
| +1.5 | | B, C | | A, B |
| +2.0 | | | | C |
| +2.5 | | | | |
| +3.0 | Z | | | |
| +3.5 | | | z | |
| +4.0 | | | | |

Examinee 3 (presbyopia)

| | |
|---|---|
| Right | Left |

| Prescription | Naked | Sample | Naked | Sample |
|---|---|---|---|---|
| +1.0 | | | | |
| +1.5 | | A, B | | A, B |
| +2.0 | | C | | C |
| +2.5 | | | | |
| +3.0 | | | | |
| +3.5 | | | | |
| +4.0 | Z | | z | |

Examinee 4 (presbyopia)

| | |
|---|---|
| Right | Left |

| Prescription | Naked | Sample | Naked | Sample |
|---|---|---|---|---|
| +1.0 | | | | |
| +1.5 | | A, B | | A |
| +2.0 | | C | | B |
| +2.5 | | | | C |
| +3.0 | | | | |
| +3.5 | z | | | |
| +4.0 | | | Z | |

Examinee 5 (presbyopia)

| | |
|---|---|
| Right | Left |

| Prescription | Naked | Sample | Naked | Sample |
|---|---|---|---|---|
| +1.0 | | | | A |
| +1.5 | | A, B | z | B |
| +2.0 | Z | | | |
| +2.5 | | | | |
| +3.0 | | | | |
| +3.5 | | | | |
| +4.0 | | C | | C |

Examinee 6 (farsightedness)

| | |
|---|---|
| Right | Left |

| Prescription | Naked | Sample | Naked | Sample |
|---|---|---|---|---|
| +1.0 | | A, B, C | | A, B, C |
| +1.5 | | | | |
| +2.0 | | | Z | |
| +2.5 | | | | |
| +3.0 | | | | |
| +3.5 | z | | | |
| +4.0 | | | | |

Examinee 7 (farsightedness)

| | |
|---|---|
| Right | Left |

| Prescription | Naked | Sample | Naked | Sample |
|---|---|---|---|---|
| +1.0 | | A | z | A, B |
| +1.5 | | B | | |
| +2.0 | | C | | C |
| +2.5 | Z | | | |
| +3.0 | | | | |
| +3.5 | z | | | |
| +4.0 | | | | |

Examinee 8 (myopia)

| | |
|---|---|
| Right | Left |

| Prescription | Naked | Sample | Naked | Sample |
|---|---|---|---|---|
| +1.0 | z | A, B | Z | A |
| +1.5 | | C | | B, C |
| +2.0 | | | | |
| +2.5 | | | | |
| +3.0 | | | | |
| +3.5 | | | | |
| +4.0 | | | | |

Examinee 9 (myopia)

| | |
|---|---|
| Right | Left |

| Prescription | Naked | Sample | Naked | Sample |
|---|---|---|---|---|
| +1.0 | Z | A, B, C | | B |
| +1.5 | | | z | A, C |
| +2.0 | | | | |
| +2.5 | | | | |
| +3.0 | | | | |
| +3.5 | | | | |
| +4.0 | | | | |

As seen from those results, as to the examinees having presbyopia, using the assistant piece sample according to the present test has led to improving the prescription of presbyopia about four steps as high as that of the naked eyes under the luminous surroundings of about 750 lux and about 250 lux while having led to improving the prescription of presbyopia about two steps as high as that of the naked eyes under the luminous surrounding of about 50 lux. Further, also as for those having farsightedness, it has led to improving the prescription of farsightedness about one step or more as high as that of the naked eyes under the same luminous surroundings. In other words, it can be said that irrespective of which eye has better power of vision, the letters whose size is half as large as those to be read with naked eyes can be understandably read and it has allowed the letters whose size is one-thirds to one-fourths as large as those to be read with naked eyes to be understandably read if the surrounding is brighter. However, as for those having myopia, hardly any improvement has been observed.

(Verification Test 4)

Then, the verification test has been carried out for tabling for discussion whether or not the diameter d of the ocular section of the present assistant piece 1 gives any influence on visibility with respect to the surrounding luminance.

To begin with, in this test, evaluation has been made, when a series of Japanese and English letters according to different letter sizes illustrated in Table 4 are seen using the same assistant piece sample as the verification test 3, as to which are the smallest letter size and the smallest diameter d of the ocular section that can be understandably read under each test surrounding luminance.

In the present test, the evaluation has been made with an eye with which the looker finds it easy to see the letters providing that the interval Z between an object for visual recognition and the sample is defined as in the order of the range from 10 to 40 cm which is adjustable at hand without fixing such interval while the interval X between the sample and the looker's eye is defined as in the order of the range from 1 to 5 cm which is adjustable even with such interval narrowed without fixing such interval either. To note, the letter sizes comprise five ones: 10 pt (about 3.53 mm), 8 pt (about 2.82 mm), 6 pt (about 2.12 mm), 5.5 pt (about 1.94 mm) and 5 pt (about 1.76 mm).

As for the sample for the present test, the perforated one has been prepared by defining the diameter d of the ocular section as O1.3 mm, O1.0 mm and O0.8 mm per line, defining the transverse interval i between the adjacent ocular sections and the vertical interval j between the ocular sections respectively as 3.5 mm; defining the diameter D of the line of vision introduction section as O3.1 mm, and defining the interval I between the ocular section and the line of vision introduction section as 4.0 mm (the processing error being in the order of ±0.1 mm for each definition).

The test results are illustrated in the following table 7. To note, the column indicated in bold denotes the combination between the smallest letter size and the smallest diameter d which the examinees answer makes the letters most understandably read.

TABLE 7

| | Luminance (lx) | | | | | | | | |
|---|---|---|---|---|---|---|---|---|---|
| | 750 | | | 250 | | | 50 | | |
| | Diameter d (mm) | | | | | | | | |
| | 0.8 | 1.0 | 1.3 | 0.8 | 1.0 | 1.3 | 0.8 | 1.0 | 1.3 |
| Letter 5.0pt | 6 | 2 | | 1 | 3 | 1 | | | 2 |
| Letter 5.5pt | 1 | | | 1 | 4 | | | 1 | 1 |
| Letter 6.0pt | | | | | | | 1 | | 1 |
| Letter 8.0pt | | | | | | | 1 | | |
| Letter 10pt | | | | | | | | | |

As seen from those results, it can be found that the range of letter sizes which can be visually recognized has changed according to the diameter d of the ocular section and the test surrounding luminance. Further, by using the assistant piece sample according to the present test, any one of the examinees can understandably read the letters of 5.0 pt to 5.5 pt in size under the surrounding luminance of about 250 lux and about 250 lux respectively while being able to understandably read those of substantially 5.0 pt to 5.5 pt in size even under the surrounding luminance of about 50 lux.

Most of the examinees find the diameter of the ocular sections 2 or O0.8 mm easiest to see the smaller letters under the surrounding luminance of about 750 lux while the number of the examinees who find the larger diameters easier to see the smaller letters increases according as the surrounding luminance lowers.

Based on the results of the verification test 1, it is considered that the interval i between the adjacent ocular sections preferably ranges from 3.0 mm to 4.5 mm, more preferably ranging from 3.5 mm to 4.0 mm in view of an error arising from difference between each individual.

Based on the results of the verification test 2, it is considered that the interval I between the line of vision introduction section and the closest ocular section preferably ranges from 3.0 mm to 4.5 mm, more preferably ranging from 3.5 mm to 4.0 mm in view of an error arising from difference between each individual. Further, in the present test, the diameter D of the line of vision introduction section is fixed at O3.1 mm, in which such diameter is favorable when it is as large as possible, but making it too large does not bring about the pinhole effect at all, so that it is preferred that it be O4.0 mm, which is the average value over O2.0 mm to O6.0 mm corresponding to the range over which the human pupils change, or smaller.

Based on the results of the verification test 4, it is considered that the diameter d of the ocular section preferably ranges from O0.5 mm to O2.0 mm in view of an error arising from difference between each individual.

In addition, the monocular human vision takes an oblong oval shape, in which it takes a further oblong oval shape with one's eyelids narrowed further when one finds it hard to see something. Therefore, it is preferred that the ocular sections 2 be disposed transversely juxtaposed with respect to the eyes.

Moreover, it is preferred that the correlation between the transverse interval i between the ocular sections, the vertical interval j between the ocular sections and the interval I between the ocular section and the line of vision introduction section be i<I≤j.

### Example in which Assistant Piece is Attached to Object for Visual Recognition in terms of Package

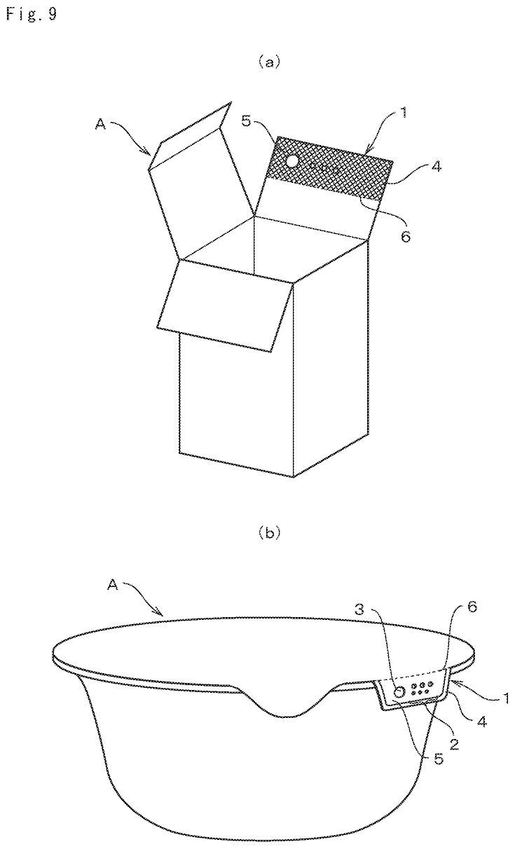

Subsequently, the second example or modified mode of the present invention is explained with reference to FIG. 9.

In the present example, as illustrated in FIG. 9, the assistant piece 1 is attached to an object for visual recognition A such that the former constitutes a part of the latter. The object for visual recognition A illustrated in FIG. 9(a) is a package box for medicine, in which it is arranged such that the sheet member 4 of the assistant piece 1 is attached to a part of the inner flap. In turn, the object for visual recognition illustrated in FIG. 9(b) is a lid of a foodstuff container (specifically, a packaging container of an instant noodle), in which it is arranged such that the sheet member 4 of the assistant piece 1 is attached in the form of a tab to a part of the lid composed of paper encapsulating an aluminum foil and polyethylene.

Further, the assistant piece 1 can be separated from the object for visual recognition A through a cut-out line portion 6 which is an intermittent cut-out.

In the mode illustrated in FIG. 9(a) according to the present example, the transverse interval i between the adjacent ocular sections 2 is defined as about 3.5 mm while the interval I between the ocular section and the line of vision introduction section 3 is defined as about 4.0 mm. Further, the diameter d of the ocular section and that D of the line of vision introduction section are defined as about O1.3 mm and O3.1 mm respectively.

The mode illustrated in FIG. 9(a) has the ocular sections 2 arranged by one line and three rows by such ocular sections being juxtaposed with the line of vision introduction section 3. This mode facilitates the users to understand how to use the assistant piece or such mode of use as peeping through the line of vision introduction section 3 and then peeping through the ocular sections 2 with simple explanatory notes described on the package box, for example. Thus, it allows the users who utilize the assistant piece 1 for the first time to readily use it. Further, the area occupied by the assistant piece 1 results in being smaller in size.

The mode illustrated in FIG. 9(b) has the ocular sections 1 arranged by the plural stages or two lines and three rows, in which the line of vision section 3 is provided in the vicinity of the endmost ocular section 2. In this regard, the diameter d of the respective ocular sections nearer to the cut-out line portion 6, that d of the other respective ocular sections and that D of the line of vision introduction section are defined as O1.3 mm, O0.8 mm and O3.1 mm respectively.

According to the mode illustrated in FIG. 9(b), by changing the diameter of the respective ocular sections 2 arranged with the plural stages, it permits the users to understandably read the letters etc. through the optimal ocular sections 2 according to their power of vision, the surrounding luminance and so on. In other words, when the users peep through the line of vision introduction section 3 at first, they result in choosing the ocular sections with either one of the diameters with which they can visually recognize the letters etc. in a clear manner from those 2 coming into their visual range, thereby, allowing them to understandably read the letters etc. with the ocular sections 2 optimal for them.

In detail, because the ocular sections 2 are arranged with two lines and three rows and the diameter d of the respective ocular sections is different according to each line, the quantity of light and the focal depth varies according to each line, thereby, permitting the scope of handling difference between each individual and difference in surrounding environment if any to expand.

In this way, by attaching the assistant piece directly to an article which requires visual recognition, it allows such piece to be utilized without fail on the spot when necessary even when one doesn't carry the vision assist tool with him/her, in which when it is provisioned to the evacuees at the shelters at the occurrence of disaster, it can dispense with the provision of spectacles and as such separately to a large number of them who take medicine and eat foodstuffs there and make them all in need utilize it with ease on the spot. In addition, at sales, there is no case where what the assistant piece 1 is attached to the objects for visual recognition leads to interrupting the marketing of such objects.

Further, the lids of the package box and the foodstuff container in terms of the objects for visual recognition A are produced generally through printing and stamping processes. The assistant piece 1 according to the present example can be produced through the addition of some blades to the stamping mold and the slight modification of printing content without the addition of another process in order to form the ocular sections 2, the line of vision introduction section 3 and the cut-out line portion 6, so that it has hardly any affect on the production cost of the objects for visual recognition A.

### Another Example in which Assistant Piece is Attached to Object for Visual Recognition in Terms of Package

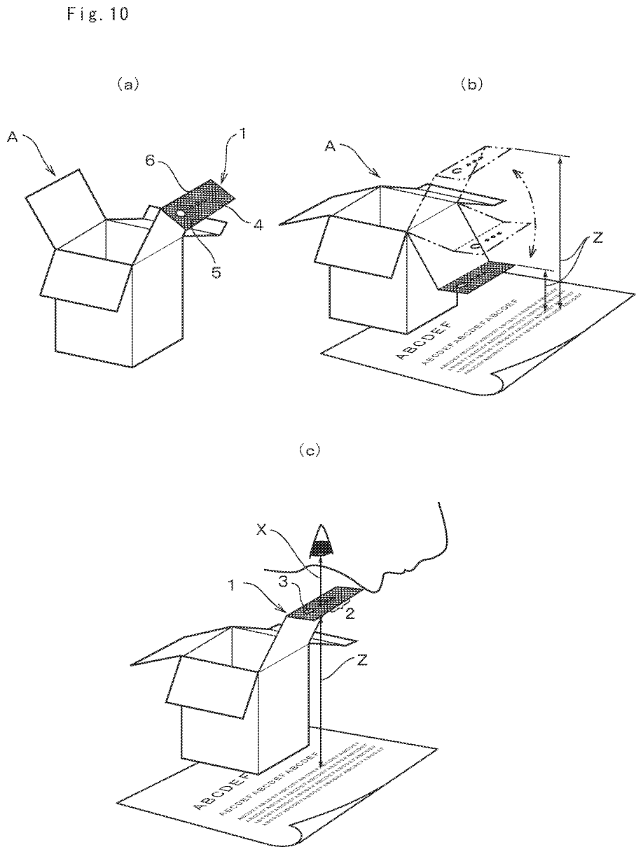

Then, the third example or another modified mode of the present invention is explained with reference to FIG. 10.

According to the present example, as illustrated in FIG. 10, the assistant piece 1 is attached to a package box of medicine such that it constitutes a part of the latter. The present example differs from the above example in that the package box of medicine is not an object for visual recognition and an inner flap on which the assistant piece 1 is attached is elongatedly formed.

Further, through the cut-out line portion 6 which is an intermittent cut-out, the assistant piece 1 is separable from the package box of medicine, but it is not separated therefrom in the present example.

In other words, as illustrated in FIG. 10(b), the package box of medicine to which the assistant piece is attached is placed on an object for visual recognition A using the former as a piece stand. Then, the inner flap is unfolded outward and the folding angle of the cut-out line portion 6 is adjusted such that the sheet member 4 of the piece 1 is substantially in parallel with the object for visual recognition A.

At this time, through the combination of the unfolding angle of the inner flap and the folding angle of the cut-out line portion 6, the interval Z between the object for visual recognition and the assistant piece is arbitrarily adjustable.

Then, as illustrated in FIG. 10(c), the letters etc. are read by making the eye come closer to the ocular sections 2 of the assistant piece 1: and shifting the package box of medicine back and forth as well as right and left sequentially while ad just ing the interval X between the piece and the user's eye and that Z between the object for visual recognition and the piece.

The above arrangement allows even those users whose hands tremble to understandably read the letters etc. in a stable manner compared with the case where the piece 1 is used separately from the package box.

### Example in which Assistant Piece is Accompanied with Object for Visual Recognition in Terms of Package as Separate Body

Then, the fourth example or another mode of the present invent ion is explained with reference to FIG. 11.

According to the present example, as illustrated in FIG. 11, the assistant piece 1 is accompanied with the object for visual recognition A as a separate body. In this regard, the object for visual recognition A is a package box of medicine and the assistant piece 1 in the form of a bookmarker is packaged in the box together with medicine and an explanatory note.

The assistant piece 1 according to the present example has the ocular sections 2 comprising the plural stages or two lines and three rows and the line of vision introduction section 3 is provided in the vicinity of the endmost ocular section 2. Further, the ocular sections 2 and the line of vision introduction section 3 are provided through perforation.

By accompanying the assistant piece 1 with the object for visual recognition A as a separate body, it permits the same to be utilized for reading the letters printed on another object for visual recognition. Further, since the assistant piece 1 formed as a separate body can be produced through stamping process at the same time as producing the package box, it is producible at a reasonable cost.

### Example in which Assistant Piece is Pasted on Bottle-Like Object for Visual Recognition as Separate Body

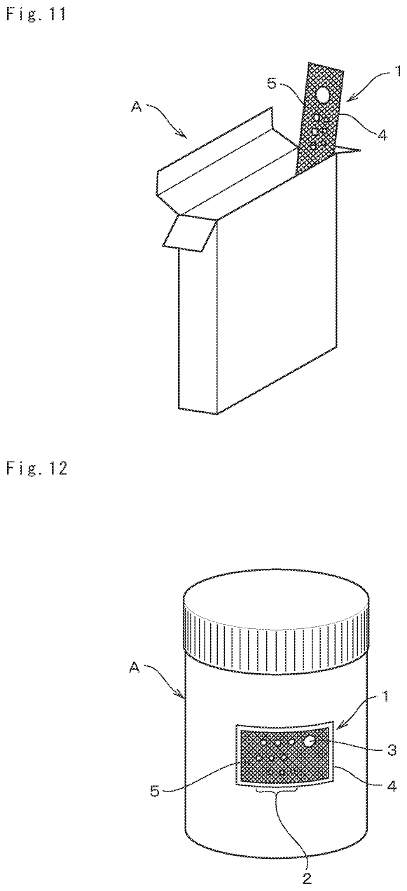

Then, the fifth example or another mode of the present invention is explained with reference to FIG. 12.

According to the present example, as illustrated in FIG. 12, the assistant piece 1 is pasted on an object for visual recognition A. In this regard, the object for visual recognition A is a bottle for medicine, in which the sheet member 4 of the assistant piece 1 is pasted on a part of the glass bottle as a detachable label.

The assistant piece 1 according to the present example, as illustrated in FIG. 12, has the ocular sections 2 compromising three lines and as many rows, in which the line of vision introduction section 3 is provided in the vicinity of the endmost ocular section 2 on the uppermost line. Further, the ocular sections 2 are staggered from one another. By disposing such sections in a staggered manner, it allows the proportional ratio of occupancy by the assistant piece 1 to the object for visual recognition to be made smaller while maintaining the same transverse interval i between the adjacent ocular sections.

Further, the sheet member 4 of the assistant piece 1 according to the present example is made of transparent polyethylene, in which the ocular sections 2, the line of vision introduction section 3 and the light-shielding section 5 are created by making the other portion of the light-shielding section excluding the corresponding portions of the ocular sections and the line of vision introduction section painted or coated with an untransparent color. This arrangement allows the assistant piece 1 to be produced without adding perforation process which is not included in the typical label production process.

### Example in which Assistant Piece is Attached to Lid of Bottle-Like Object for Visual Recognition

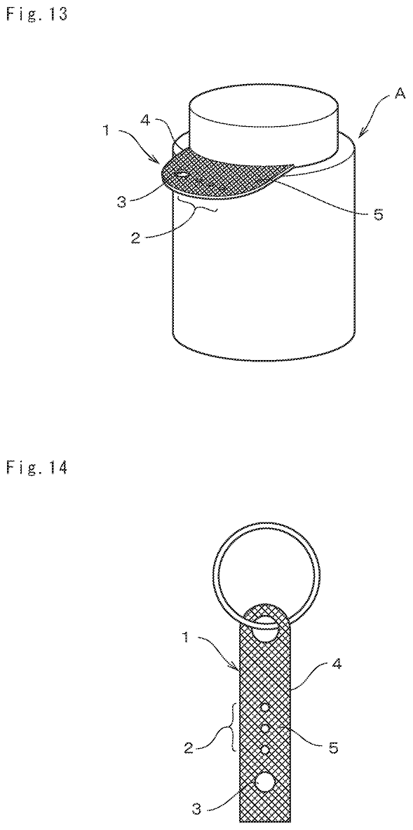

Moreover, the sixth example or another mode of the present invention is explained with reference to FIG. 13.

According to the present example, as illustrated in FIG. 13, the assistant piece 1 is attached to an object for visual recognition A such that it constitutes a part of the latter. In this regard, the object for visual recognition A is a bottle for nutritional supplements (so-called supplements) and the like, in which the assistant piece 1 is attached to such object as a part of the lid tab.

The assistant piece 1 according to the present example has the ocular sections 2 and the line of vision introduction section 3 arranged in the same way as illustrated in FIG. 1, in which since the lid is made of an untransparent thermoplastic resin such as polypropylene, the entire sheet member 4 results in constituting the light-shielding section 5.

Further, the ocular sections 2 and the line of vision introduction section 3 can be formed by opening through a mold when the lid is subjected to injection molding, so that their formation hardly affects the production cost of the lid.

### Example on Card-Like Assistant Piece

Furthermore, the seventh example or another mode of the present invention is explained with reference to FIG. 14.

According to the present example, as illustrated in FIG. 14, the assistant piece 1 is formed into a sole card-like shape without being attached to an object for visual recognition A and is arranged such that it can be suspended on a hook with a ring and the like.

According to the present example, the sheet member 4 is made of a resinous sheet such as polyethylene with which it can be produced at a reasonable cost, in which it is illustrated the single piece is suspended, but plural assistant pieces 1, which respectively have the discrete diameter d of the ocular sections and the discrete transverse interval i between the adjacent ocular sections, may well be suspended in bundle.

Further, the sheet member 4 may well be made of paper, in which by suspending plural pieces, they may well be stripped off one by one when necessary.

This arrangement permits those pieces to be suspended at the shelters and the like, thereby, enabling the evacuees to readily read the letters etc. printed on a package box and so on.

In addition, the pieces can be produced at a reasonable cost, so that it allows a tool, which enables the customers at retailing shops in general such as supermarkets to read prices and the like printed on a product package or label, to be provided.

### Example on Assistant Piece Attached to Cap Portion of Thermometer

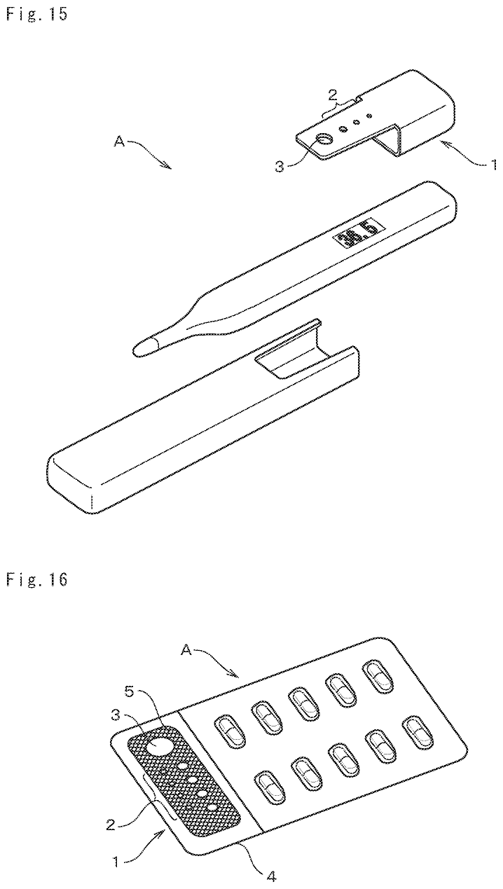

Furthermore, the eighth or another mode of the present invention is explained with reference to FIG. 15.

The assistant piece 1 according to the present example, as illustrated in FIG. 15, is arranged such that it constitutes a part of an adjunct article of an object for visual recognition A. In this regard, the object for visual recognition A is a thermometer, in which it is arranged such that the sheet member 4 of the piece 1 is attached to a part of the thermometer cap. Because the cap is stored along with the thermometer in pair, the display section can be visually recognized through the ocular sections 2 every time the measured value is checked.

Further, the ocular sections 2 are arranged with one line and three rows in juxtaposition with the line of vision introduction section 3, in which the present example differs from the second example in that the respective ocular sections have a different diameter d from each other in one line.

On account that the diameters d of the ocular sections are arranged to be different from each other in one line, the latitude in the quantity of light and the focal depth is widened, which allows the users to select the ocular sections 2 optimal for them according to difference between each individual and the luminance of the surrounding environment. To note, this example, compared with the mode in which the ocular sections having the same diameter are juxtaposed with one another, is more effective for reading the letters etc. in the order of several letters such as displayed temperature and price tags rather than for reading long sentences.

The present invention is implemented substantially as described above, but it is not limited to the examples illustrated herein or it can be modified into various manners. By way of some examples, the assistant piece 1 may well be arranged such that it is attached to a part of the blister pack for medicine as embodied in the ninth example illustrated in FIG. 16 or formed on the tickets such as train ones or on the envelopes to receive such tickets therein.

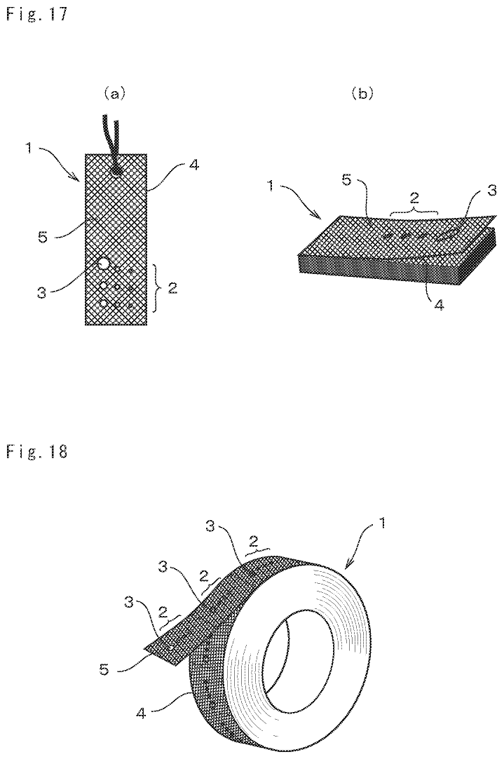

Further, the assistant piece 1 may well be arranged on a part of what we have at hand such as bookmarkers and sticky notes as embodied in the tenth example illustrated in FIGS. 17(a) and (b) or may well be formed consecutively into a roll-like tape with cut-out line portions as embodied in the eleventh example illustrated in FIG. 18 to be used by severing it by what is needed.

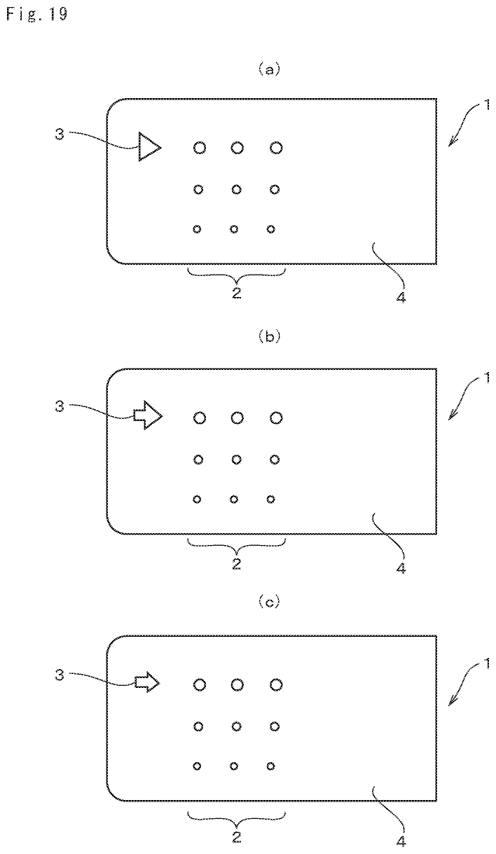

Moreover, the line of vision introduction section 3 may take other shapes such as polygons and figures other than circle. In the twelfth example illustrated in FIGS. 19(a), (b) and (c), the line of vision introduction section 3 has such a shape as a triangle whose apex is directed to the ocular sections 2 or an arrow indicating the direction to the ocular sections 2.

In this case, even in the case where the users have power of vision with which the minute holes of the ocular sections 2 cannot be visually recognized, just because the line of vision introduction section 3 is larger than the ocular sections, so that they can be aware of the triangle or arrow being directed to the ocular sections 2, which facilitates them to grasp the presence of the ocular sections 2, thereby, leading for them to being able to read the letters etc. peeping through the ocular sections 2.

Furthermore, the shape of the ocular sections 2 is not limited to circle, but may well be polygonal and as such. However, such a shape as having a large number of angles and being approximate to circle is preferable in order to bring about the pinhole effect more effectively.

In addition, as for the twelfth example, the line of vision introduction section 3 may be arranged such that it is not perforated, but printed with a light-shielding color ink or pasted there in the form of a separate label.

In this case, just because the line of vision introduction section 3 is larger than the ocular sections 2 and is a triangle or arrow directed to the ocular sections 2, the line of vision introduction section 3 itself attracts the users' attention, so that they can visually recognize the line of vision introduction section 3 clearly even in the case where they have power of vision with which they cannot visually recognize the minute holes or pinholes, which leads for them to being able to visually recognize the ocular sections 2 coming into their visual range at the same time as they visually recognize the line of vision introduction section 3.

### REFERENCE SIGNS LISTING

1 . . . Assistant Piece
2 . . . Ocular Section
3 . . . Line of Vision Introduction Section
4 . . . Sheet Member
5 . . . Light-shielding Section
6 . . . Cut-out Line Portion
A . . . Object for Visual Recognition
D . . . Diameter of Line of Vision Introduction Section
d . . . Diameter of Ocular Section
I . . . Interval between Ocular Section and Line of Vision Introduction Section
i . . . Transverse Interval between Adjacent Ocular Sections
j . . . Vertical Interval between Ocular Sections
B . . . Lens
C . . . Retina
E . . . Light Source
F . . . Focal Point
G . . . Focal Depth
P . . . Pinhole
X . . . Interval between Assistant Piece and User's Eye
Z . . . Interval between Object for Visual Recognition and Assistant Piece

1. An assistant piece to help read descriptions with ease comprising a plurality of ocular sections each having a prescribed area which are provided in juxtaposition on a plate-like sheet member and through which light penetrates and a line of vision introduction section which is provided in the vicinity of the ocular sections and has a larger light penetrating area than the ocular sections, wherein the sheet member is provided with a light-shielding section whose transmittance over visible light is lower than those of the ocular sections and the line of vision introduction section; and the ocular sections and the line of vision introduction section are provided within the light-shielding section.

2. The assistant piece according to claim 1, wherein an interval between the adjacent ocular sections ranges from 3.0 mm to 4.5 mm, and an interval between the line of vision introduction section and the closest ocular section ranges from 3.0 mm to 4.5 mm.

3. The assistant piece according to claim 2, wherein the interval between the line of vision introduction section and the closest ocular section be the same as or larger than that between the adjacent ocular sections.

4. The assistant piece according to claim 1, wherein an aerial size of the ocular section or converted into circle diameter ranges from O0.5 mm to O2.0 mm and that of the line of vision introduction section is O4.0 mm or smaller.

5. The assistant piece according to claim 4, wherein the aerial size of the line of vision introduction section is twice as large as that of the ocular section or much larger than that.

6. The assistant piece according to claim 1, wherein the ocular sections are arranged with plural lines, an interval between the respective lines being 4.0 mm or larger or being the same as that between the line of vision introduction section and the closest ocular section or larger than that.

7. The assistant piece according to claim 1, wherein the sheet member is formed into separable pieces while being attached to an object for visual recognition.
